(19) United States
(12) Patent Application Publication
(10) Pub. No.: US 2012/0310124 A1
(43) Pub. Date: Dec. 6, 2012

(54) LIQUID DISPENSING MASSAGE DEVICE WITH DOUBLE SWITCH

(75) Inventor: JUN ZHANG, GUANG DONG PROVINCE (CN)

(73) Assignee: CHUEN CHERN CO., LTD., TAIPEI COUNTY (TW)

(21) Appl. No.: 13/152,318

(22) Filed: Jun. 3, 2011

(51) Int. Cl. A61H 1/00

(52) U.S. Cl. 601/46

(57) ABSTRACT

A liquid dispensing massage device includes a container having an opening and adapted to contain a quantity of liquid; a spring biased dispensing assembly comprising a retaining cap releasably secured to the opening of the container; a massage assembly comprising a shell mounted on an outer surface of the container and a vibration unit disposed in the shell, the vibration unit comprising a DC motor, a manually moveable first switch mounted on the shell, a PCB, and a battery; and a second switch electrically interconnected to the motor and the first switch and comprising a spring depressible member and a sliding trigger having one end engaged with the spring depressible member and the other end projecting out of the shell to engage with an outer surface of the opening of the container. The motor is activated when both switches are on.

### BACKGROUND OF THE INVENTION

1. Field of the Invention

The invention relates to vibration type liquid dispensers and more particularly to a liquid dispensing massage device having two switches so that an activation of the device is made possible only when both switches are on in order to prevent the device from being activated in an inoperative position due to an inadvertent movement of one switch.

2. Description of Related Art

A conventional roll-on type dispenser comprises a container for storing a quantity of liquid, a retaining cap releasably secured to a top of the container, and a ball rotatably disposed on a top opening of the container. A user may rotate the ball which picks up liquid in the container and applies same to the body area on which the ball is rolled. As a result, blood circulation is stimulated, muscles are made supple, and the user may have a feeling of coolness.

There is a conventional liquid dispensing massage device available. Although it has enjoyed wide use due to convenience in use and portability, it has presented some problems. For example, switch of the conventional liquid dispensing massage device may be inadvertently turned on due to contact when it is placed in a pocket or bag. Further, battery of the conventional liquid dispensing massage device may quickly consume if a user did not notice the unintended activation of the switch and turned it off immediately. Thus, the user may find the conventional liquid dispensing massage device being inoperable due to battery low when such needs arises. Battery replacement is thus often. To the worse, electric motor of the conventional liquid dispensing massage device may malfunction due to a long period of continuous use. Buying of a new liquid dispensing massage device is thus inevitable. Moreover, it is typical that only one vibration strength is available (i.e., no vibration strength control with vibration strength adjustment being impossible) for the conventional liquid dispensing massage device. Thus, the need for improvement still exists.

### SUMMARY OF THE INVENTION

It is therefore one object of the invention to provide a liquid dispensing massage device having two switches so that an activation of the device is made possible only when both switches are on in order to prevent the device from being activated in an inoperative position due to an inadvertent movement of one switch.

For achieving above and other objects, the invention provides a liquid dispensing massage device comprising a container having an opening and adapted to contain a quantity of liquid; a spring biased dispensing assembly comprising a retaining cap releasably secured to the opening of the container; a massage assembly comprising a shell mounted on an outer surface of the container and a vibration unit disposed in the shell, the vibration unit comprising a DC (direct current) motor, a manually moveable first switch mounted on the shell, a printed circuit board (PCB), and a battery wherein the battery is electrically interconnected to the motor and the first switch, and the DC motor can be set to rotate at a predetermined speed; and a second switch electrically interconnected to the DC motor and the first switch and comprising a spring depressible member and a sliding trigger having one end engaged with the spring depressible member and the other end projecting out of the shell to engage with an outer surface of the opening of the container; wherein in response to securing the retaining cap to the opening of the container the dispensing assembly is disabled with the liquid being prevented from flowing out of the container, and the DC motor is deactivated to depress the sliding trigger which in turn depresses the spring depressible member so as to disable the second switch; and wherein in response to removing the retaining cap the dispensing assembly is enabled with the liquid being adapted to flow out of the container, and the sliding trigger is pushed away from the second switch by the spring depressible member to enable the second switch so that a manual movement of the first switch to an on position activates the DC motor.

The above and other objects, features and advantages of the invention will become apparent from the following detailed description taken with the accompanying drawings.

### BRIEF DESCRIPTION OF THE DRAWINGS

FIG. 1 is an exploded view of a liquid dispensing massage device according to the invention;

FIG. 2 is a longitudinal sectional view of the assembled liquid dispensing massage device with both switches being off and the liquid flow path being stopped;

FIG. 3 is a view similar to FIG. 2 with the retaining cap removed, the first switch being off, and the second switch being on; and

FIG. 4 is a view similar to FIG. 3 showing the liquid being dispensed after further turning the first switch to an on position.

### DETAILED DESCRIPTION OF THE INVENTION

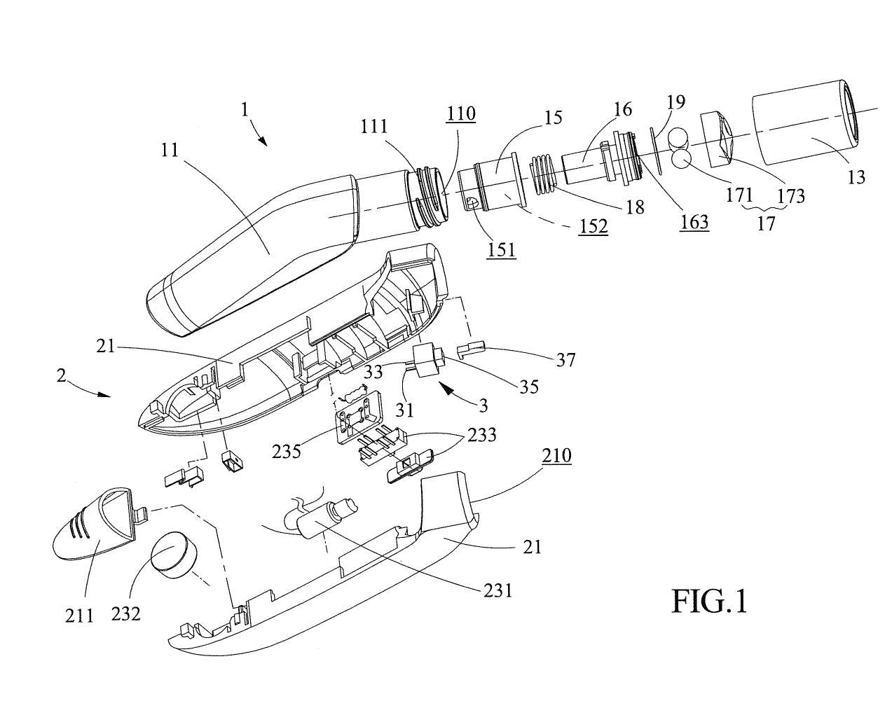

Referring to FIGS. 1 to 4, a liquid dispensing massage device 1 in accordance with the invention comprises the following components as discussed in detail below.

A dispensing assembly 10 and a container 11 for storing a quantity of liquid (e.g., lotion) are provided. The container 11 has a main section, a bent section, and a head section. In detail, the container 11 comprises an opening 110 and external threads 111 on an outer surface of the opening 110. The external threads 111 are threadably secured to internal threads 131 on an inner surface of a lower portion of a retaining cap 13 so as to secure the container 11 and the retaining cap 13 together.

The dispensing assembly 10 is provided at the head of the container 11 and comprises a sleeve 15, a sliding tube 16, a spout 17, and a compression spring 18. The sleeve 15 is fixed at the opening 110 of the container 11 and comprises an annular inlet opening 151 at one end and a channel 152 being in communication with the inlet opening 151. The sliding tube 16 is partially disposed in the sleeve 15 and comprises a passageway 161 having one end projecting out of one end of the sleeve 15 and the other end complimentarily secured to an inner surface of the spout 17. The compression spring 18 is disposed in the channel 152 to be biased between an annular outer flange of the sliding tube 16 and an internally extending rim at one end of the sleeve 15 so that the sliding tube 16 can slide by the expansion or compression of the compression spring 18. The spout 17 comprises an annular support 173 and a plurality of partially exposed balls 171 rotatably supported by the support 173 and retained in a plurality of hollow seats 163 at the other end (i.e., head) of the sliding tube 16. The retaining cap 13 further comprises an annular urging member 133 extending from the underside of the top. The annular urging member 133 pushes both the spout 17 and the sliding tube 16 inward by pressing against the balls 171 when the retaining cap 13 is secured to the container 11 by threading. A sealing ring 19 is provided in the support 173 for preventing liquid stored in the container 11 from leaking when the liquid dispensing massage device 1 is not in use.

A massage assembly 2 is mounted on the main and bent sections of the container 11 and comprises a shell 21 and a vibration unit 23 disposed in the shell 21. The vibration unit 23 comprises a DC (direct current) motor 231, a first switch 233 mounted on the shell 21 to be manually operable, a printed circuit board (PCB) 235, and a battery 232. The battery 232 is electrically interconnected to the motor 231 and the first switch 233. The motor 231 can be set to operate at a constant speed. Vibration strength of the activated motor 231 can be controlled by moving the first switch 233 to one of at least position other than on and off positions thereof in cooperation with the PCB 235 as detailed later.

The shell 21 consists of two mating sections and comprises a neck 210 at one end to be complimentarily secured to the head section of the container 11, and a cover 211 releasably secured to the other end of the shell 21 for covering the battery 232. A user may open the cover 211 to remove a consumed battery 232.

A second switch 3 comprises a positive terminal 31, an adjacent negative terminal 33, a spring depressible member 35 distal both the positive and negative terminals 31, 33, and a sliding trigger 37 having one end engaged with the spring depressible member 35 and the other end projecting out of the shell 21 to engage with an outer surface of the opening 110 of the container 11. The sliding trigger 37 is pushed by the retaining cap 13 to depress the spring depressible member 35 so as to disable the second switch 3 when the retaining cap 13 and the container 11 are threadedly secured together (i.e., in a storage or inoperative position).

A first conductor 24 is electrically interconnected to a positive terminal of the battery 232 and a negative terminal of the motor 231. A second conductor 25 is electrically interconnected to a negative terminal of the battery 232 and a positive terminal of the PCB 235. A third conductor 26 is electrically interconnected to a negative terminal of the PCB 235 and the positive terminal 31 of the second switch 3. A fourth conductor 27 is electrically interconnected to the negative terminal 33 of the second switch 3 and a positive terminal of the motor 231.

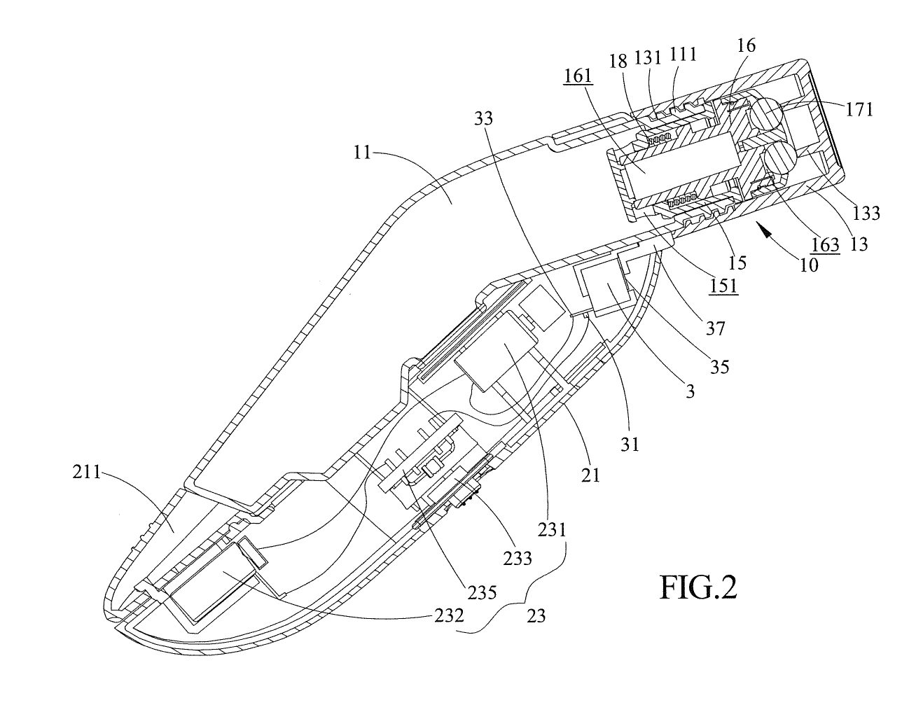

An off operation of the invention will be described in detailed below. After closing the container 11 by threadedly securing the retaining cap 13 thereto, the sliding trigger 37 is pushed inward to dispose the second switch 3 in an off position due to the depressing of the spring depressible member 35 (i.e., being energized) and thus an electrical disconnection of the positive and negative terminals 31, 33. Also, the compression spring 18 is compressed (i.e., energized). Further, the sliding tube 16 is pushed toward the opening 110 of the container 11 to close the inlet opening 151 and stop liquid flow path (see FIG. 2). Therefore, an inadvertent movement of the first switch 233, for example, by the hand will not close the circuit to supply electric current from the battery 232 to the motor 231 for vibration because the second switch 3 is off. This is a safe mechanism of the liquid dispensing massage device 1 envisioned by the invention.

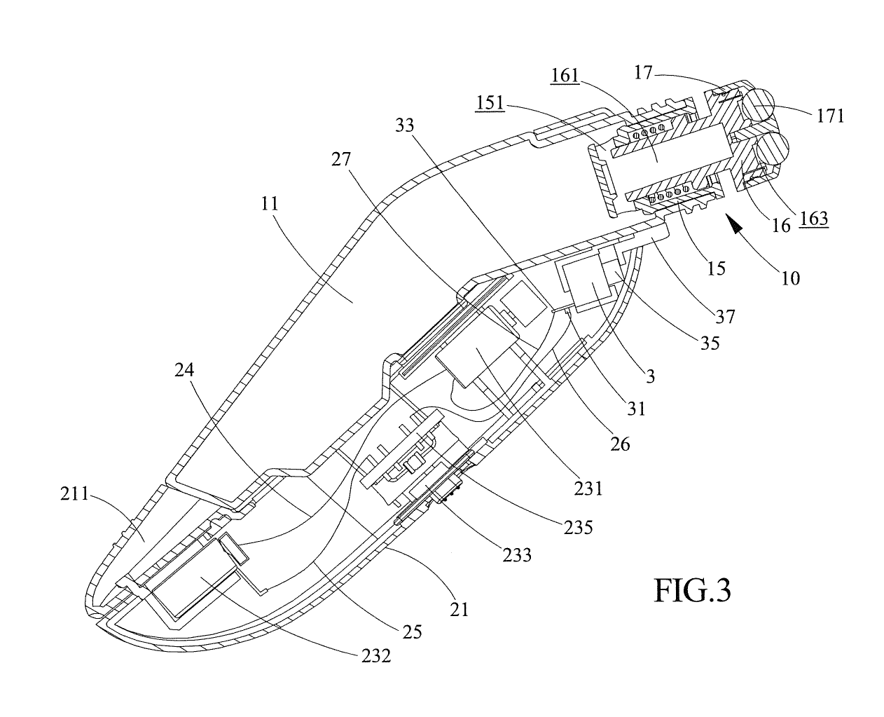

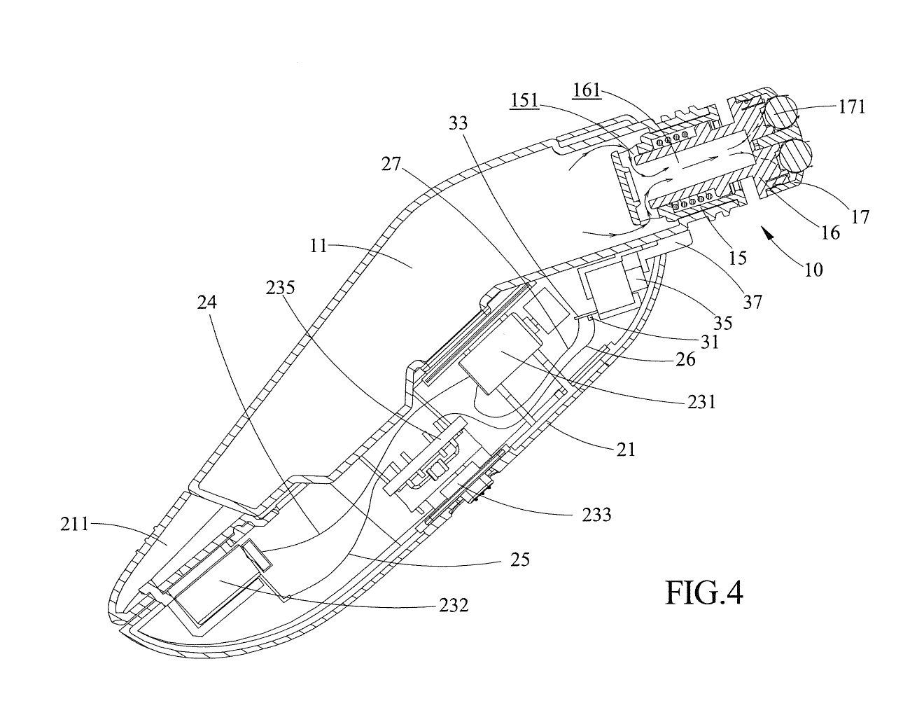

An on operation of the invention will be described in detailed below. The sliding trigger 37 is pushed outward by the energized spring depressible member 35 after removing the retaining cap 13 out of the container 11 (see FIG. 3). Thus, the second switch 3 is on due to an electrical interconnection of the positive and negative terminals 31, 33. And in turn, the sliding tube 16 is pushed out of the opening 110 of the container 11 a short distance due to both the removal of the retaining cap 13 and the expansion of the energized compression spring 18. Hence, liquid in the container 11 can flow to the balls 171 via the inlet opening 151, the passageway 161, and the hollow seats 163 as indicated by arrows in FIG. 4 in conjunction with FIG. 2. Moreover, a user may manually push the first switch 233 from an off position to an on position so as to cause the battery 232 to supply electric current to the motor 231 for activation. Thus, the motor 231 may vibrate while the user rubs the skin by the dispensed liquid. As a result, a massage effect to the user is brought about. Moreover, the user may manually move the first switch 233 to one of at least position other than the on and off positions of the first switch 233 in cooperation with the PCB 235 if different vibration strength modes (e.g., strong, intermediate, and weak vibration strengths) of the activated motor 231 are desired. That is, a vibration strength control of the liquid dispensing massage device 1 is envisioned by the invention.

While the invention has been described in terms of preferred embodiments, those skilled in the art will recognize that the invention can be practiced with modifications within the spirit and scope of the appended claims.

What is claimed is:

1. A liquid dispensing massage device comprising:
a container having an opening and adapted to contain a quantity of liquid;
a spring biased dispensing assembly comprising a retaining cap releasably secured to the opening of the container;
a massage assembly comprising a shell mounted on an outer surface of the container and a vibration unit disposed in the shell, the vibration unit comprising a DC (direct current) motor, a manually moveable first switch mounted on the shell, a printed circuit board (PCB), and a battery wherein the battery is electrically interconnected to the motor and the first switch, and the DC motor can be set to rotate at a predetermined speed; and
a second switch electrically interconnected to the DC motor and the first switch and comprising a spring depressible member and a sliding trigger having one end engaged with the spring depressible member and the other end projecting out of the shell to engage with an outer surface of the opening of the container;
wherein in response to securing the retaining cap to the opening of the container the dispensing assembly is disabled with the liquid being prevented from flowing out of the container, and the DC motor is deactivated to depress the sliding trigger which in turn depresses the spring depressible member so as to disable the second switch; and
wherein in response to removing the retaining cap the dispensing assembly is enabled with the liquid being adapted to flow out of the container, and the sliding trigger is pushed away from the second switch by the spring depressible member to enable the second switch so that a manual movement of the first switch to an on position activates the DC motor.

2. The liquid dispensing massage device of claim 1, wherein the container comprises external threads on the opening thereof, and wherein the retaining cap comprises internal threads threadably secure to the external threads to fasten the retaining cap and the container together, and an internal urging member.

3. The liquid dispensing massage device of claim 1, wherein the dispensing assembly comprises a sleeve, a sliding tube, a spout, and a compression spring, and wherein the sleeve is fixed at the opening of the container and comprises an inlet opening at one end and a channel communicating with the inlet opening, the sliding tube is partially disposed in the sleeve and comprises a passageway having one end projecting out of one end of the sleeve and the other end complimentarily secured to an inner surface of the spout, and the compression spring is disposed in the channel to be retained between the sliding tube and the sleeve so that expansion or compression of the compression spring slides the sliding tube.

4. The liquid dispensing massage device of claim 1, wherein the shell comprises a neck at one end to be complimentarily secured to a bent portion the container proximate to the opening of the container, and a cover releasably secured to the other end of the shell for covering the battery.

5. The liquid dispensing massage device of claim 1, wherein the dispensing assembly further comprises a sealing ring disposed in the spout for preventing the liquid in the container from leaking when the dispensing assembly is disabled.

6. The liquid dispensing massage device of claim 1, wherein vibration strength of the DC motor can be controlled by moving the first switch to one of at least position other than on and off positions thereof in cooperation with the PCB.
